(19) United States
(12) Patent Application Publication
(10) Pub. No.: US 2016/0065680 A1
(43) Pub. Date: Mar. 3, 2016

(54) MULTI-NODE DISTRIBUTED NETWORK ACCESS SERVER DESIGNED FOR LARGE SCALABILITY

(71) Applicant: rift.IO,Inc., Burlington, MA (US)

(72) Inventors: Matthew Hayden HARPER, Salem, NH (US); Timothy Glenn MORTSOLF, Amherst, MA (US)

(73) Assignee: rift.IO, Inc., Burlington, MA (US)

(21) Appl. No.: 14/836,440

(22) Filed: Aug. 26, 2015

Related U.S. Application Data
(60) Provisional application No. 62/042,017, filed on Aug. 26, 2014.

(51) Int. Cl. H04L 29/08; G06F 9/455

(52) U.S. Cl. CPC H04L 67/16; G06F 9/45558; H04L 67/1002; G06F 2009/45595

(57) ABSTRACT

Disclosed herein are system, method, and computer program product embodiments for providing a network access service. An embodiment operates by receiving a request for a network access service of a collective, the request including one or more operations to be performed by the network access service, in which the collective comprises sectors and is a first level of a multi-tier hierarchy for distributing the network access service across a plurality of virtual machines; distributing the one or more operations to the sectors of the collective, in which each of the sectors comprises a set of configurable resources related to a physical topology of the sector; and transmitting results of the one or more operations performed by at least some of the configurable resources.

### CROSS REFERENCE TO RELATED APPLICATIONS

This application claims the benefit of U.S. Provisional Patent Application No. 62/042,017 (Atty. Docket No. 3561.0060000), filed Aug. 26, 2014, titled “MULTI-NODE DISTRIBUTED NETWORK ACCESS SERVER DESIGNED FOR LARGE SCALABILITY,” which is hereby incorporated herein by reference in its entirety.

### BACKGROUND

Generally, networking applications require larger hardware to scale vertically, whereas cloud-based applications request additional discrete hardware resources to scale horizontally. Distributed network services that support networking access services generally partition control operations into differentiated processes that each play separate roles in the processing of control and management functions. For example, the Service Availability Framework (SAF) partitions the hardware components for control operations into an active/standby pair of centralized system controller nodes and a variable set of control nodes. As another example, the OpenStack high availability infrastructure uses the Pacemaker cluster stack to manage processes within a cluster. However, these services are limited in the number of processes that they can manage while maintaining the appearance of a single network access service. When these limits are exceeded, these approaches require additional hardware resources that prevent the services they offer from appearing as single network access services.

### SUMMARY

Provided herein are system, apparatus, article of manufacture, method and/or computer program product embodiments, and/or combinations and sub-combinations thereof, for distributing a network access service.

### BRIEF DESCRIPTION OF THE DRAWINGS

The accompanying drawings are incorporated herein and form a part of the specification.

FIG. 1 is a block diagram of a system, according to an example embodiment.

FIG. 2 is a block diagram of a container hierarchy, according to an example embodiment.

FIG. 3 is a flowchart illustrating a process for generating a platform configuration, according to an example embodiment.

FIG. 4 is a block diagram of a colony, according to an example embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

### Network Access Service Platform

A network access service (NAS) platform can be used to distribute a NAS that both appears as a single NAS and runs in a distributed fashion across a large number of virtual machines. The virtual machines can be distributed locally (such as in large densities, e.g. those within an OpenStack zone), distributed geographically (such as across virtual machines, e.g. those that run within separate OpenStack zones), or any combination thereof. These network access services can be modeled in a multi-level hierarchy that reflects the high availability and proximity relationships between these virtual machines. The hierarchical distribution of NAS platform across a large number of nodes in a cloud network that spans a collection of multiple geographical data centers allows a NAS to autonomously scale across many thousands of nodes while still maintaining the properties of a singly managed network access service.

The NAS platform can provide network services that scale the signaling plane and/or bearer plane across a large set of cloud computing devices that can collectively act as a large distributed cloud networking appliance. The platform can be configured to allow a single networking service to collectively scale in the signaling plane up to at least 10 billion subscriber sessions, and in the data plane up to at least 10 Terabits of bearer plane traffic. The platform uses a multi-tier hierarchy of operational containers to distribute a single networking service across thousands of virtual machines.

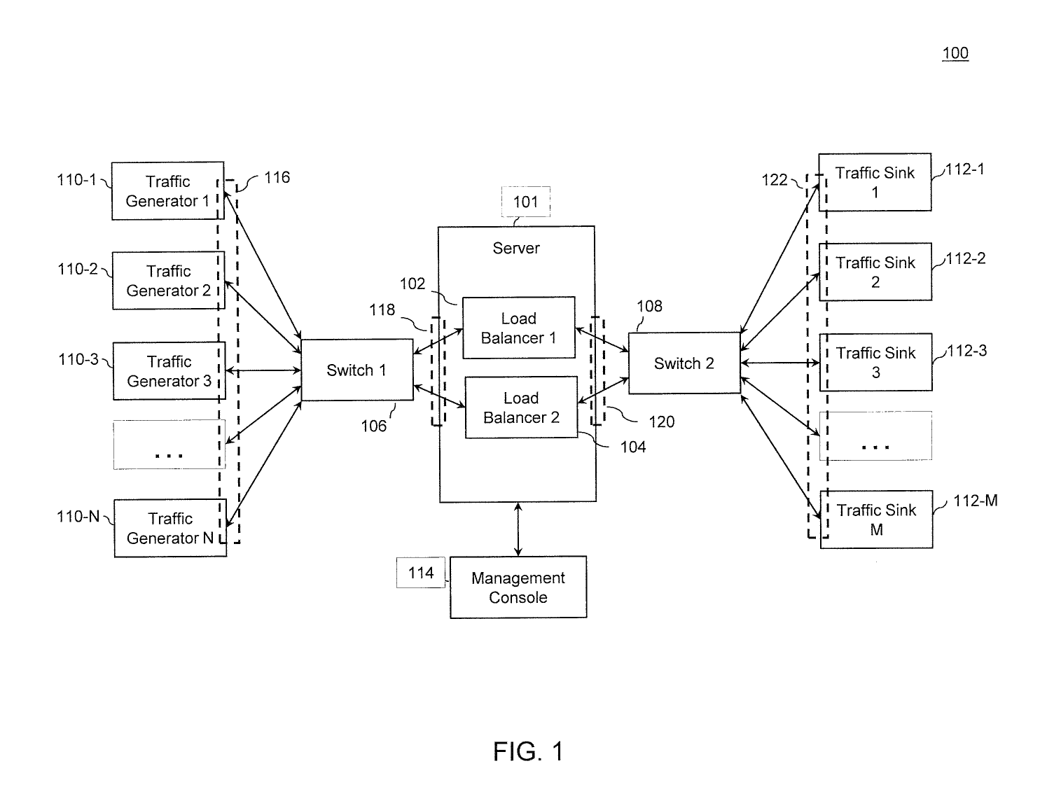

FIG. 1 is a block diagram of an example system 100 that provides a network access service and includes server 101, load balancer 1 102, load balancer 2 104, switch 1 106, switch 2 108, one or more traffic generators 1-N (110-1 through 110-N), one or more traffic sinks 1-M (112-1 through 112-M), and management console 114. Although system 100 is depicted as having two load balancers, two switches, N traffic generators, and M traffic sinks, embodiments of the invention support any number of load balancers, switches, traffic generators, traffic sinks, and management consoles. Further, it is understood that N and M are variables that can be any number.

The one or more traffic generators 1-N may generate traffic, such as bearer plane and/or signaling traffic. The generated traffic may be intended for a recipient, such as load balancers 1 and 2, switches 1 and 2, the one or more traffic sinks 1-M, or any combination thereof. The recipient may be specified in the traffic, specified separately from the traffic, derived from the traffic, or determined by one or more of the elements of FIG. 1, such as by switch 1, switch 2, load balancer 1, or load balancer 2. In an embodiment, the one or more traffic generators are instances of virtual machines (VMs).

A switch may be a networking device that is used to connect devices together on a network, e.g. by using a form of packet switching to forward data to the destination device. A switch may be configured to forward a message to one or multiple devices that need to receive it, rather than broadcasting the same message out of each of its ports. A switch may perform as a multi-port network bridge that processes and forwards data at the data link layer (layer 2) of the OSI model. Switches can also incorporate routing in addition to bridging; these switches are commonly known as layer-3 or multilayer switches. Switches exist for various types of networks including Fibre Channel, Asynchronous Transfer Mode, InfiniBand, Ethernet and others.

Switch 1 may connect traffic generators 1-N to load balancers 1 and 2. Switch 1 may receive traffic from the one or more traffic generators 1-N and forward this traffic to load balancer 1 or load balancer 2, may receive traffic from load balancer 1 or load balancer 2 and forward this traffic to one or more of the one or more traffic generators 1-N, or any combination thereof. Switch 1 can be any switch, such as those discussed above.

A load balancer may be a device that distributes one or more workloads across multiple computing resources, such as VMs, computers, a computer cluster, network links, central processing units, disk drives, processes, tasks, etc.. Load balancing can improve resource use, throughput, response time, and avoid overload of any one of the resources. Using multiple components with load balancing instead of a single component may increase reliability through redundancy.

Server 101 includes load balancers 1 and 2. Load balancers 1 and/or 2 may receive and/or transmit traffic via switches 1 and/or 2. Load balancers 1 and/or 2 may perform one or more operations to determine how to distribute the traffic and/or workloads related to processing the traffic for providing a NAS within system 100. For example, load balancer may allocate one or more tasks to process, one or more processes to a virtual machine, etc.

Switch 2 can be any switch, such as those discussed above. Switch 2 may connect traffic sinks 1-M to load balancers 1 and 2. Switch 2 may receive traffic from the one or more traffic sinks 1-M and forward this traffic to load balancer 1 or load balancer 2, may receive traffic from load balancer 1 or load balancer 2 and forward this traffic to one or more of the one or more traffic sinks 1-M, or any combination thereof.

The one or more traffic sinks 1-M may receive traffic from switch 2. The one or more traffic sinks 1-M may use the traffic to provide or support providing a NAS. In an embodiment, the one or more traffic generators are instances of VMs.

Load balancers 1 and 2, switches 1 and 2, the one or more traffic generators 1-N, and the one or more traffic sinks 1-M may communicate over one or more networks, which can be any network or combination of networks that can carry data communications. Such a network can include, but is not limited to, a local area network, metropolitan area network, and/or wide area network that include the Internet.

In an embodiment, multiple connections from different elements are aggregated into link aggregation groups (LAGs). Link aggregation may refer to one or more methods of combining (aggregating) multiple network connections in parallel, for example to increase throughput beyond what a single connection could sustain, to provide redundancy in case one of the links fail, or any combination thereof. For example, LAG 116 can aggregate the connections between traffic generators 1-N and switch 1; LAG 118 can aggregate the connections between switch 1 and load balancers 1 and 2; LAG 120 can aggregate the connections between switch 2 and load balancers 1 and 2; and LAG 122 can aggregate the connections between switch 2 and traffic sinks 1-M. Although these particular LAGs 116, 118, 120, and 122 are shown, embodiments support aggregating other combinations and/or sub-combinations of connections into one or more other LAGs.

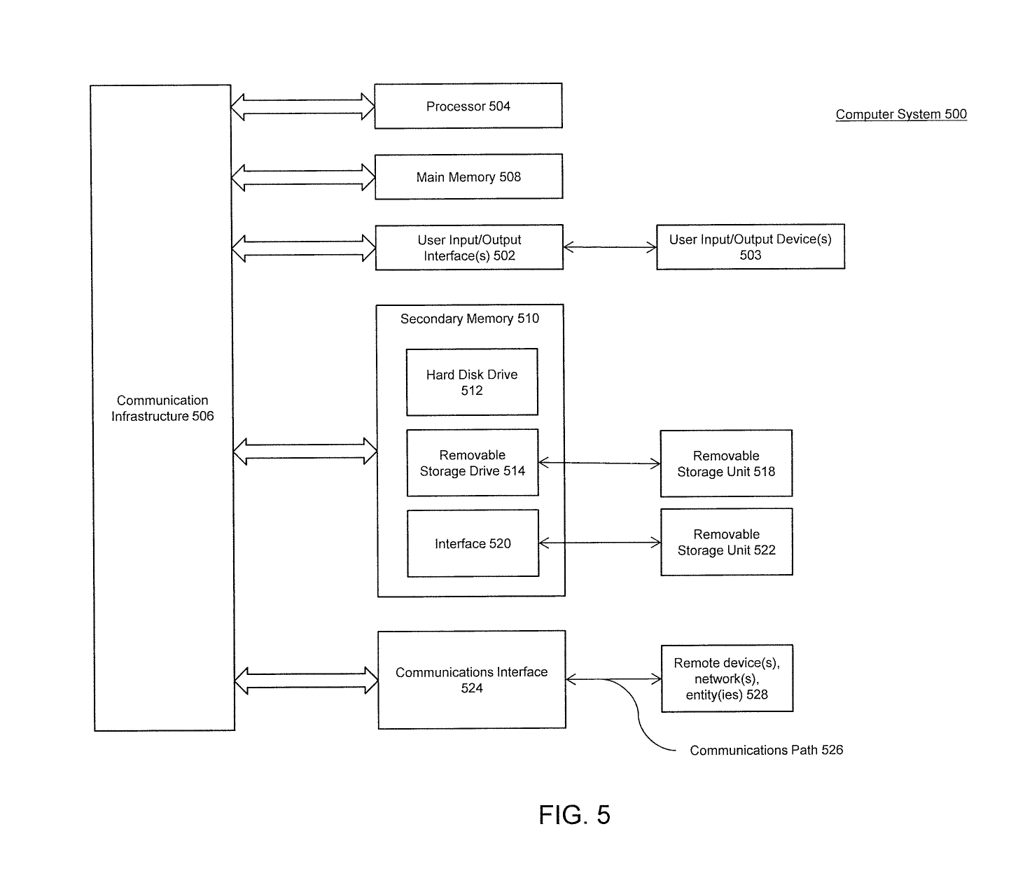

Management console 114 may be any computing system, such as the example computing system 500 depicted in FIG. 5. Management console 114 may interface with server 101 to provide server management functionalities, such as those discussed herein. Although management console 114 is depicted separately from the server 101, it is understood that management console 114 and server 101 may be the same device.

### Container Hierarchies

In data processing terminology, according to an embodiment, a container is a computing object that contains instance(s) of other computing objects. There are many types of containers in the data processing world. In the C programming language, a struct is a C data type that contains other C types. The Core Foundation collection library implements a set of classes that are used to store and manage groups of objects into different types of containers -- array, bags, dictionary, hash, sets, and trees. Linux Containers (LXC) are a form of operating system virtualization that run isolated operating system instances on a single Linux host. Linux Containers isolate groups of application processes and their corresponding kernel services into shielded sandbox-like containers.

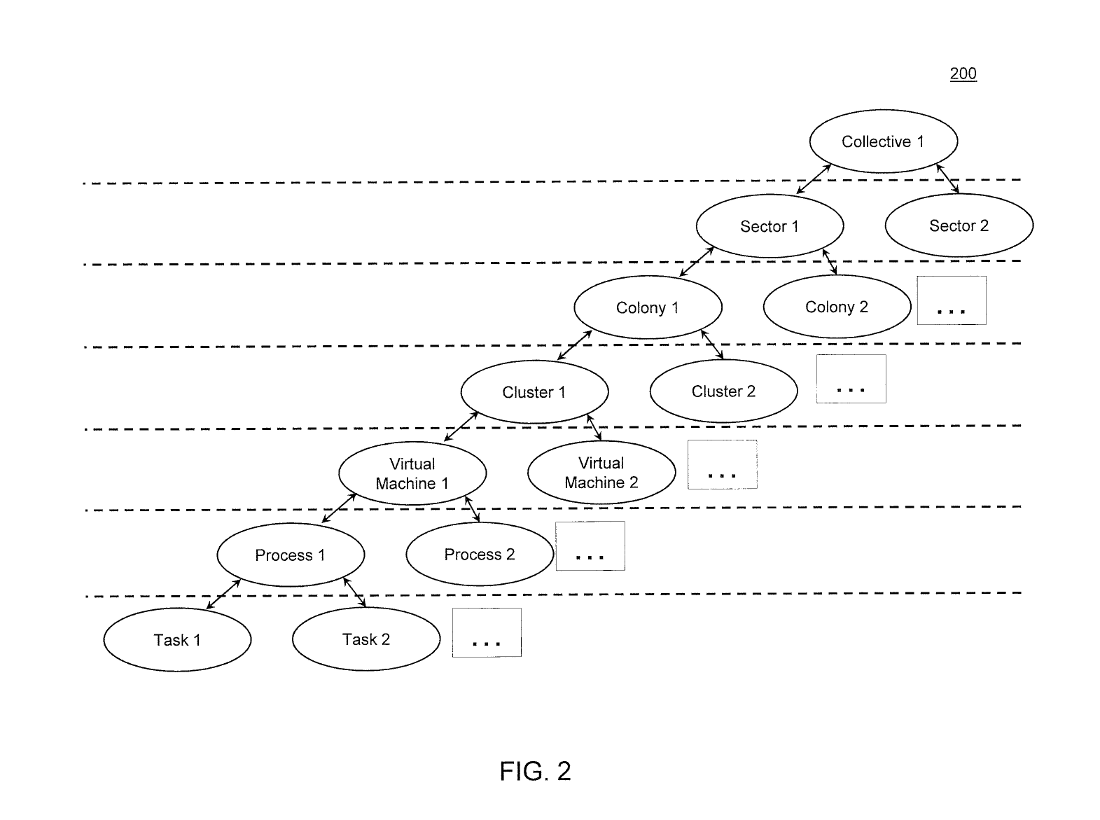

In this disclosure, in example embodiments, an operational container is a computing object that contains instance(s) of running software methods. These operational containers are organized into a hierarchical group, e.g. to meet product or software architecture specifications. FIG. 2 is a block diagram of an operational container hierarchy 200, according to an example embodiment. Container hierarchy 200 includes a collective level, a sector level, a colony level, a cluster level, a virtual machine (VM) level, a process level, and a task level. Any, some, or all of the elements of a NAS platform (e.g. those shown in FIG. 1) may be assigned to one or more operational containers within a hierarchy.

In an embodiment, the collective level includes one or more collectives. A collective is a container that does not necessarily contain any network service agents, but is used to manage and distribute the processing nodes that perform the network access related functions for the service. In an embodiment, a collective represents the first tier of a NAS.

Any, some, or all of the one or more collectives can include one or more sectors. For illustrative purposes, FIG. 2 depicts collective 1 has having two sectors as children. However, a collective can support any number of sectors.

The sector level includes one or more sectors. Networking services contain per sector configuration that represent the geographical constraints of particular service. For example, parameters such as network interfaces, IP address assignments (such as a different IP address for each data center), and computing resources are all example elements that are assigned to a particular sector of a networking service. Resources within a collective that are partitioned can be assigned to individual sectors. A sector can also be subdivided into a subsector or area when further partitioning of physical or logical resources is desired. In an embodiment, a sector represents the second tier for a NAS, such as a data center.

Any, some, or all of the one or more sectors can have one or more colonies as children. For illustrative purposes, FIG. 2 depicts sector 1 has having two colonies. However, a sector can support any number of colonies.

The colony level includes one or more colonies. A colony contains one or more virtual machines that form an elasticity group that manages a subset of the signaling and data for a particular NAS. In an embodiment, a colony is the third tier of the hierarchy used to manage VMs for a distributed NAS. For example, a colony may represent one or more racks within a data center.

In an embodiment, high availability failure recovery actions are performed within an individual colony. For example, if a virtual machine fails, it is restarted within the colony. Any state that is required for the new virtual machine can be replicated by a subsystem that replicates state across machines within the colony, such as a Distributed Transaction System (DTS) that replicates state across machines within the colony. Alternatively or additionally, a DTS can perform transactions from the collective down through sectors into individual colonies. A DTS may be implemented by a database, such as a transactional database.

Any, some, or all of the one or more colonies can have one or more clusters as children. For illustrative purposes, the example of FIG. 2 depicts colony 1 has having two clusters. However, a colony can support any number of clusters.

The cluster level includes one or more clusters. Any, some, or all of the one or more clusters can have one or more VMs as children. For illustrative purposes, FIG. 2 depicts collective 1 has having two VMs. However, a cluster can support any number of VMs.

The VM level includes one or more VMs. The VMs can be implemented by one or more computing systems, such as the example computing system 500 depicted in FIG. 5.

Any, some, or all of the one or more VMs can have one or more processes as children. For illustrative purposes, FIG. 2 depicts VM 1 has having two processes. However, a VM can support any number of processes.

The process level includes one or more tasks. Any, some, or all of the one or more processes can have one or more tasks as children. For illustrative purposes, FIG. 2 depicts process 1 has having two tasks. However, a collective can support any number of tasks.

The task level includes one or more tasks, e.g. threads.

A hierarchy can be configured in multiple ways. In an embodiment, the hierarchy is strictly enforced, meaning that the only parent/child relationships can be collective/sector, sector/colony, colony/cluster, cluster/VM, VM/process, and process/thread, respectively. In an embodiment, the hierarchy is not strictly enforced, meaning that any container type can be a child of another container type, as long as the child container type appears in any level of the hierarchy below the parent container type.

### Generating the Platform Configuration

In an embodiment, a platform configuration may refer to a data set comprising one or more parameters. The one or more parameters can include, for example, one or more assignments of one or more resources to the one or more operational containers in a hierarchy, the relationship of one or more operational containers in a hierarchy to one or more other operational containers in the hierarchy, configuration options for the one or more resources, instructions for a NAS coordination application (NCA), or any combination thereof. In an embodiment, the platform configuration provides information regarding each operational container in a hierarchy of the NSA platform.

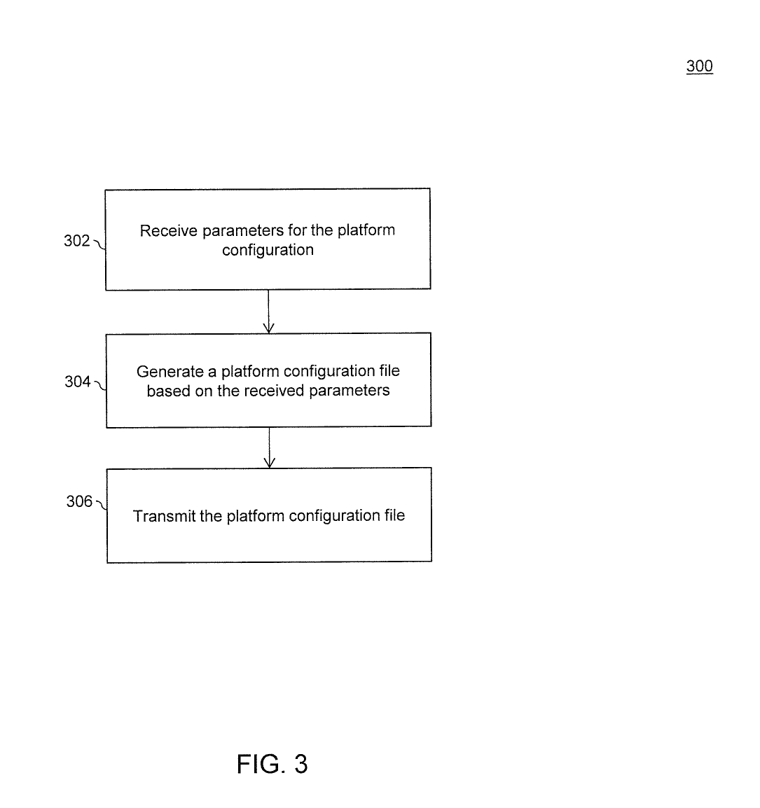

FIG. 3 is a flowchart illustrating a process 300 for generating a platform configuration, according to an example embodiment. Process 300 can be performed by processing logic that can comprise hardware (e.g., circuitry, dedicated logic, programmable logic, microcode, etc.), software (e.g., instructions run on a processing device), or a combination thereof. For example, process 300 may be performed by management console 114, or by the example computing system 500 depicted in FIG. 5.

In block 302, parameters for the platform configuration are received. In an embodiment, management console 114 receives the platform configuration. The parameters received can include any, some, or all of the parameters for the platform configuration. The parameters can be received in or derived from a parameter configuration script (PCS).

In an embodiment, the parameters are included in a PCS. A PCS may be script (e.g. a script written in python, javascript, peri, etc.) that when executed or interpreted, generates a platform configuration file. The PCS can be human or machine generated. Alternatively or additionally, the script may include calls to an application programming interface (API), wherein the API facilitates creating a script that will properly validate. For example, the API may provide functionalities to interact with the hierarchy.

In block 304, a platform configuration file (PCF) is generated based on the received platform configuration parameters. The PCF specifies the platform configuration. In an embodiment, management console 114 generates the PCF. For example, management console 114 may execute or interpret a PCS, and the execution or interpretation generates the PCF. In an embodiment, the PCS is validated (e.g. by an application executing on management console 114) prior to generating the PCF, while generating, the PCF, after generating the PCF, or any combination thereof.

The PCF can include details for any portion or all resources in the NAS platform. For example, the PCF may include details for all resources in the NAS platform. This type PCF can then be used by any NCA in the NAS platform to understand the relationships between the one or more resources the NCA is managing and other resources or NCAs in the platform. As another example, the PCF may include the details particular to a particular NCA and the resources or other NCAs the NCA is responsible for interacting with.

In an embodiment, the PCF includes specifications for one or more state machines. For example, the PCF may include the details for implementing a state machine that can be run by any NCA running in the NAS platform. As another example, the PCF can include a state machine specific to a NCA or a type of NCA on which it is to be run.

The PCF can be of any format. In an embodiment, the PCF is a YANG (e.g RFC 6020) compliant XML file.

In block 306, the PCF is transmitted to one or more NCAs. In an embodiment, management console 114 transmits the PCF to one or more NCAs. For example, netconf may be used to send the PCF to an resource in the NAS platform. Although this and other approaches for transmitting the PCF are discussed herein, embodiments support any approach to transmitting the PCF to one or more NCAs.

### NAS Coordination Applications

A NAS Coordination Application (NCA) may refer to software, such as a process or thread, that executes on one or more resources of a NAS platform. A NCA can be configured to interpret a PCF and manage one or more resources accordingly. For example, a NCA can be used to start, facilitate, or stop cloud genesis, one or more processes, one or more threads, one or more NCAs, as well as any other resources in the NAS platform. For example, a first NCA may start a second NCA, which in turn starts a third NCA, etc. In an embodiment, NCAs corresponding to parent nodes can start or stop child nodes, but child nodes do not start parent nodes. Alternatively or additionally, another service (e.g. Apache ZooKeeper), can be used as distributed configuration service, synchronization service, and naming registry for the NCAs or other resources in the NAS platform.

In an embodiment, an NCA has an awareness of one or more of its parents and/or children in the hierarchy, and can transmit or receive messages from them. Similarly, the NCA may have an awareness of one or more other NCAs assigned to the same or a different resource in the hierarchy, and can transmit or receive messages from them. Regardless of the relationship, the messages can include heartbeats (e.g. keep-alive messages or acknowledgements) that can be used to determine the availibity, connectivity, or status of one or more other resources or NCAs.

In an embodiment, one or more NCAs execute on any, some, or all of the resources assigned in the hierarchy of a NAS platform. The NCAs of the resources may be the same application, different applications, or any combination thereof.

A registrar within a process can be used to inventory the components within a particular resource in the NAS platform hierarchy. A NCA inventory manager (NIM) may manage, add, edit, or delete resource information from the registrar. Additionally or alternatively, a NIM can transmit or receive updates from other NIMs, and update the registrar accordingly.

In an embodiment, each element in the hierarchy forms a colony of distributed VMs. An inventory of all components within a colony can be registered in a registrar within any process. The registrar may be accessed by a party quorum and replication facility to mirror the state of all of these components registered within it, for example, by an external third-party quorum and replication facility.

In an embodiment, a colony contains three virtual machines with each containing a NCA and a NIM. In this configuration, one of these virtual machines may act as a leader and perform all of the operations, while the other processes run on the other virtual machines in a hot standby role.

The NCAs provide a number of significant advantages for managing a NAS platform. Because, the NCAs can be configured to run a state machine specified by the PCF, global changes to the NAS platform can be implemented simply by changing the PCF and distributing it to the NCAs. Further, inter-NCA communication can be used to manage and ensure that resources in the NCAs are functioning properly, both in a distributed manner.

Communication within the NAS Platform

Resources within the NAS platform, such as NCAs, can communicate with each other in multiple ways. In an embodiment, resources communicate using packets that are encoded within tunnel headers. For example, a task or NCA can send a packet encoded within tunnel headers to one or more other tasks or NCAs. In another embodiment, resources communicate by passing stateless messages to their parent and/or child nodes within the hierarchy. For example, a NCA can send heartbeats and/or request/response messages to parent and/or child NCAs. In a further embodiment, resources communicate using a DTS. For example, tasks or NCAs can include function callbacks to a DTS for transmitting and/or receiving messages.

### Example Implementation of a Platform Configuration

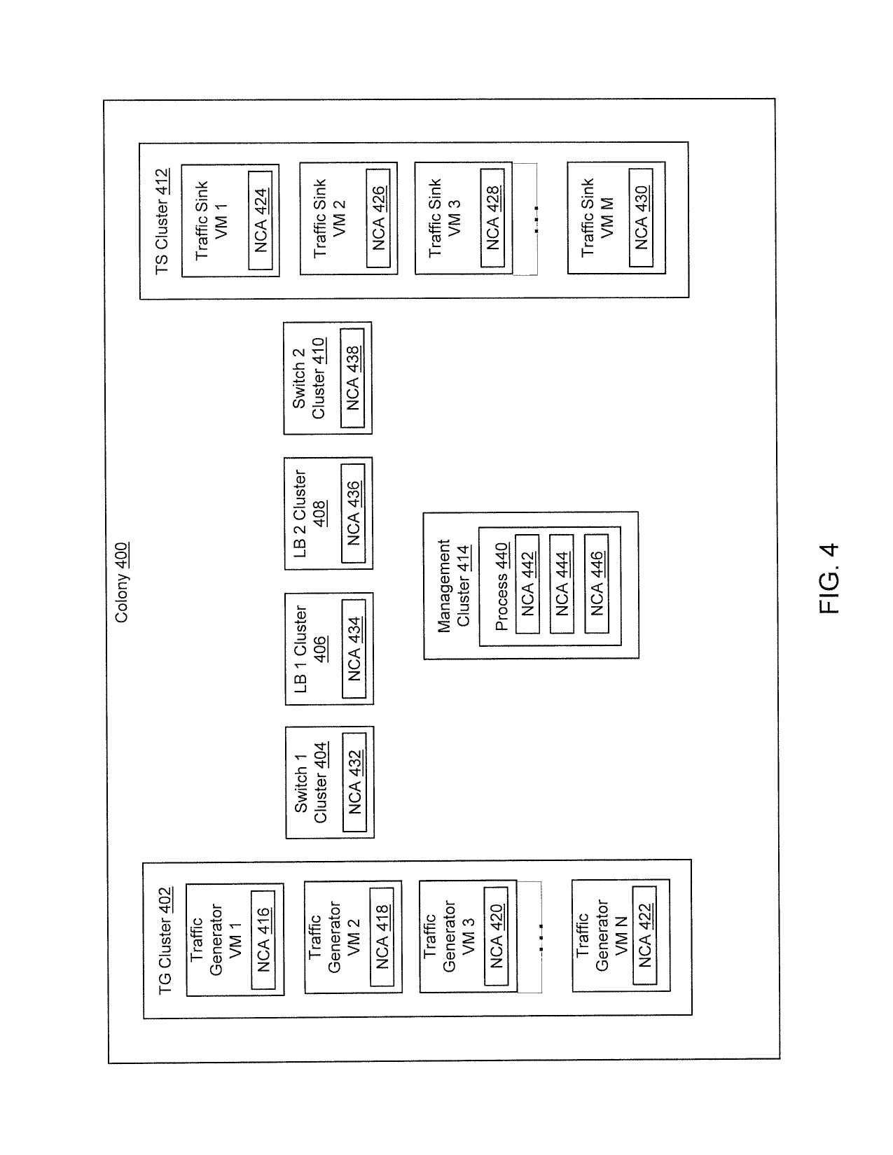

FIG. 4 is a block diagram of an example colony 400 for modeling system 100. In FIG. 4, child or descendent containers are depicted as nested within their parent or other ancestor containers. However, the nesting is to be interpreted as a logical relationship in the hierarchy, and not necessarily a physical relationship. For ease of understanding, some intermediate containers have been omitted from FIG. 4, such as process containers in the traffic generator VM elements.

As discussed above, the configuration of a NAS platform can be specified in a PCF. For example, a PCF may define the roles of the various resources in FIG. 1 in the hierarchy of a NAS platform. In this example shown by FIG. 4, the same PCF is used by each of the NCAs and specifies global system configuration.

Colony 400 includes traffic generator cluster 402, switch 1 cluster 404, load balancer 1 cluster 406, load balancer 2 cluster 408, switch cluster 410, traffic sink cluster 412, and management cluster 414, which correspond to the group of one or more traffic generators 1-N, switch 1 106, load balancer 1 102, load balancer 2, switch 2 108, group of one or more traffic sinks 1-M, and management console 114, respectively.

Traffic generator cluster 402 includes traffic generator VMs 1-N, which correspond to traffic generators 1-N. Each of traffic generator VMs 1-N include a NCA, which are depicted by NCAs 416, 418, 420, and 422. In this example, these NCAs are implemented as tasks running within processes of their respective parent VMs.

Switch 1 cluster 404 corresponds to switch 1 106 and includes NCA 432. Switch 1 cluster 404 corresponds to switch 1 106 and includes NCA 432. Load balancer 1 cluster 406 corresponds to load balancer 1 102 and includes NCA 434. Load balancer 2 cluster 408 corresponds to load balancer 2 104 and includes NCA 436. Switch 2 cluster 410 corresponds to switch 2 108 and includes NCA 438. In this example, these NCAs are implemented as tasks running within their ancestor or parent containers.

Management cluster 414 includes process 440, and process 440 includes NCAs 442, 444, and 446. NCAs 442, 444, and 446 may be implemented as tasks running in process 440. NCAs 442, 444, and 446 can be implemented in a lead-standby-standby configuration, in which NCA 442 is lead NCA, and NCAs 444 and 446 are available in hot standby mode.

Traffic sink cluster 412 includes traffic sink VMs 1-M, which correspond to traffic generators 1-M. Each of traffic sink VMs 1-M include a NCA, which are depicted by NCAs 424, 426, 428, and 430. In this example, these NCAs are implemented as tasks running within processes of their respective parent VMs.

In an embodiment, NCA 442 initiates cloud genesis. NCA 442 is specified as the lead NCA 442 by the PCF. The PCF also indicates that NCA 442 is to generate a cloud according to the PCF. As a result, NCA 442 starts execution of NCAs 444 and 446. NCA 442 also starts execution of remaining NCAs in colony 400, such as 416, 418, 420, 422, 424, 426, 428, 430, 432, 434, 436, and 438.

When the other NCAs start, they each refer to PCF and begin executing the state machine specified therein. Because the state machine in the PCF describes the behavior of the resources associated with the NCA, the NCA will configure its corresponding resource appropriately. For example, NCA 416 will configure traffic generator VM 1, including beginning any processes on VM 1. A similar approach is used by NCAs 418, 420, 422, 424, 426, 428, and 430 to configure their corresponding resources. Similarly, when NCAs 432 and 438 begin running, they will execute the state machine specified in the PCF, which will result in the NCAs configuring switches 1 and 2, respectively. Further, when NCAs 434 and 436 being running, they will execute the state machine specified in the PCF, which will result in the NCAs configuring load balancers 1 and 2, respectively. As the various resources of colony 400 become configured, they are able to provide the NAS while appearing as a single NAS.

In an embodiment, colony 400 can be reconfigured by propagating a new or modified PCF to colony 400′s NCAs. The modifications to the PCF may be made by any of colony 400′s NCAs. Modifications can be propagated using any, some, or all of the communication techniques discussed herein. As a result, the entire NAS platform can be reconfigured by the time it takes for the revised PCF to be propagated throughout the platform and the NCAs to restart.

### Example Computer System

Various embodiments can be implemented, for example, using one or more well-known computer systems, such as computer system 500 shown in FIG. 5. Computer system 500 can be any well-known computer capable of performing the functions described herein, such as computers available from International Business Machines, Apple, Sun, HP, Dell, Sony, Toshiba, etc.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 500 also includes user input/output device(s) 503, such as monitors, keyboards, pointing devices, etc., which communicate with communication infrastructure 506 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/ any other computer data storage device. Removable storage drive 514 reads from and/or writes to removable storage unit 518 in a well-known manner,

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 5. In particular, embodiments may operate with software, hardware, and/or operating system implementations other than those described herein.

### Conclusion

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A method for providing a network access service, comprising:
receiving, by at least one resource of a collective, a request for the network access service, the request including one or more operations to be performed by the network access service, wherein the collective comprises sectors and is a first level of a multi-tier hierarchy for distributing the network access service across a plurality of virtual machines;
distributing, by the at least one resource of the collective, the one or more operations to the sectors of the collective, wherein each of the sectors comprises a set of configurable resources related to a physical topology of the sector; and
transmitting, by the at least one resource of the collective, results of the one or more operations performed by at least some of the configurable resources.

2. The method of claim 1, wherein the sectors perform the one or more operations using high-availability separately-configured data over multiple separately-configured networking services.

3. The method of claim 2, wherein the multiple separately-configured networking services are dynamically reconfigured while the one or more operations are being performed.

4. The method of claim 1, wherein the configurable resources include at least one of a computing system, a virtual machine, an Internet Protocol (IP) address, an IP address pool, a network interface, a routing protocol, or any combination thereof.

5. The method of claim 1, wherein at least one sector of the sectors includes and manages a set of colonies, wherein each of the colonies acts autonomously of the other colonies within the sector.

6. The method of claim 5, wherein at least one colony of the colonies comprises a multi-tier hierarchy of clustered virtual machines, and wherein the at least one colony distributes the one or more operations across the virtual machines.

7. The method of claim 5, further comprising:
bootstrapping the virtual machines for synchronization or leadership election using a distributed configuration service external to the colony.

8. A system, comprising:
a memory; and
at least one processor coupled to the memory and configured to:
receive a request for a network access service of a collective, the request including one or more operations to be performed by the network access service, wherein the collective comprises sectors and is a first level of a multi-tier hierarchy for distributing the network access service across a plurality of virtual machines;
distribute the one or more operations to the sectors of the collective, wherein each of the sectors comprises a set of configurable resources related to a physical topology of the sector; and
transmitting the results of the one or more operations performed by at least some of the configurable resources.

9. The system of claim 8, wherein the sectors perform the one or more operations using high-availability separately-configured data over multiple separately-configured networking services.

10. The system of claim 9, wherein the multiple separately-configured networking services are dynamically reconfigured while the one or more operations are being performed.

11. The system of claim 8, wherein the configurable resources include at least one of a computing system, a virtual machine, an Internet Protocol (IP) address, an IP address pool, a network interface, a routing protocol, or any combination thereof.

12. The system of claim 8, wherein at least one sector of the sectors includes and manages a set of colonies, wherein each of the colonies acts autonomously of the other colonies within the sector.

13. The system of claim 12, wherein at least one colony of the colonies comprises a multi-tier hierarchy of clustered virtual machines, and wherein the at least one colony distributes the one or more operations across the virtual machines.

14. The system of claim 12, the at least one processor further configured to:
bootstrap the virtual machines for synchronization or leadership election using a distributed configuration service external to the colony.

15. A tangible computer-readable device having instructions stored thereon that, when executed by at least one computing device, causes the at least one computing device to perform operations comprising:
receiving a request for a network access service of a collective, the request including one or more operations to be performed by the network access service, wherein the collective comprises sectors and is a first level of a multi-tier hierarchy for distributing the network access service across a plurality of virtual machines;
distributing the one or more operations to the sectors of the collective, wherein each of the sectors comprises a set of configurable resources related to a physical topology of the sector; and
transmitting results of the one or more operations performed by at least some of the configurable resources.

16. The computer-readable device of claim 15, wherein the sectors perform the one or more operations using high-availability separately-configured data over multiple separately-configured networking services.

17. The computer-readable device of claim 16, wherein the multiple separately-configured networking services are dynamically reconfigured while the one or more operations are being performed.

18. The computer-readable device of claim 15, wherein the configurable resources include at least one of a computing system, a virtual machine, an Internet Protocol (IP) address, an IP address pool, a network interface, a routing protocol, or any combination thereof.

19. The computer-readable device of claim 15, wherein at least one sector of the sectors includes and manages a set of colonies, wherein each of the colonies acts autonomously of the other colonies within the sector.

20. The computer-readable device of claim 19, wherein at least one colony of the colonies comprises a multi-tier hierarchy of clustered virtual machines, and wherein the at least one colony distributes the one or more operations across the virtual machines.
